(19) United States
(12) Patent Application Publication
(10) Pub. No.: US 2018/0079675 A1
(43) Pub. Date: Mar. 22, 2018

(54) THERMALLY ENHANCED GLASS MANUFACTURING APPARATUS AND METHOD

(71) Applicant: Corning Incorporated, Corning, NY (US)

(72) Inventors: Bushra Afzal, Painted Post, NY (US); Anmol Agrawal, Horseheads, NY (US); Kenneth William Aniolek, Painted Post, NY (US); John Michael Feenaughty, Arkport, NY (US); Ming-Huang Huang, Ithaca, NY (US); Gautam Narendra Kudva, Horseheads, NY (US); Shawn Rachelle Markham, Harrodsburg, KY (US); Ilia Andreyevich Nikulin, Painted Post, NY (US)

(21) Appl. No.: 15/566,833

(22) PCT Filed: Apr. 8, 2016
(86) PCT No.: PCT/US2016/026553

§ 371 Date: Oct. 16, 2017

Related U.S. Application Data
(60) Provisional application No. 62/148,870, filed on Apr. 17, 2015.

(51) Int. Cl. C03B 17/06

(52) U.S. Cl. CPC C03B 17/067; C03B 17/064

(57) ABSTRACT

A glass forming apparatus and method include a cooling mechanism in a wall of the apparatus that enhances radiation heat transfer between the glass and the wall of the apparatus and is tunable in both the vertical and horizontal directions. The apparatus and method also include a heating mechanism that affects radiation heat transfer between the glass and the wall of the apparatus, is tunable in both the vertical and horizontal directions, and is independently operable from the cooling mechanism.

This application claims the benefit of priority under 35 U.S.C. §365 of International Patent Application Serial No. PCT/US16/26553, filed on Apr. 8, 2016, which claims the benefit of priority under U.S. Provisional Application Ser. No. 62/148,870, filed on Apr. 17, 2015, the content of are relied upon and incorporated herein by reference in their entirety.

### BACKGROUND

### Field

The present disclosure relates generally to a thermally enhanced glass manufacturing apparatus and method and more specifically to a glass manufacturing apparatus and method that is thermally enhanced for high glass flow rates.

### Technical Background

In the manufacture of glass materials, such as flat glass substrates for display applications, such as LCD televisions and handheld electronic devices, there is a continual desire to increase molten glass flow rates. As flow rates of molten glass increase, more energy is imputed into the manufacturing process. As more energy in imputed into the manufacturing process, the temperature of the glass inside of a glass manufacturing apparatus will increase, all else being equal. Such increased temperature may lead to at least one of many potential undesirable effects including reduced stability of the molten glass as well as one or more undesirable product attributes.

When the glass manufacturing process involves fusion drawn glass, attempts to maintain the baseline cooling curve at varying flow rates (to maintain desired glass properties) can include at least one changes in elements designed to effectuate controlled cooling and changes relating to thermal insulation configurations. However, such techniques may not be adequate to address increasingly high molten glass flow rates and reduced average formed glass thicknesses. In addition, it would be advantageous to be able to have increased capacity to tailor the thermal profile of the cooling curve in both the vertical and horizontal directions, especially at high molten glass flow rates and reduced glass thicknesses, under which conditions it is more difficult to tailor the cooling curve in either direction.

### SUMMARY

Disclosed herein is an apparatus for producing a glass article. The apparatus includes a cooling mechanism in at least one wall of the apparatus that enhances radiation heat transfer between molten glass and the wall of the apparatus and is tunable in both the vertical and horizontal directions. The cooling mechanism provides increased radiation heat transfer from the glass ribbon to a wall of the apparatus relative to a condition where such cooling mechanism is absent. The apparatus also includes a heating mechanism that affects radiation heat transfer between molten glass and the wall of the apparatus, is tunable in both the vertical and horizontal directions, and is independently operable from the cooling mechanism. The heating mechanism provides decreased radiation heat transfer from the glass ribbon to a wall of the apparatus relative to a condition where such heating mechanism is absent.

Also disclosed herein is a method of producing a glass article that includes forming the glass article in an apparatus. The apparatus includes a cooling mechanism in at least one wall of the apparatus that enhances radiation heat transfer between molten glass and the wall of the apparatus and is tunable in both the vertical and horizontal directions. The cooling mechanism provides increased radiation heat transfer from the glass ribbon to a wall of the apparatus relative to a condition where such cooling mechanism is absent. The apparatus also includes a heating mechanism that affects radiation heat transfer between molten glass and the wall of the apparatus, is tunable in both the vertical and horizontal directions, and is independently operable from the cooling mechanism. The heating mechanism provides decreased radiation heat transfer from the glass ribbon to a wall of the apparatus relative to a condition where such heating mechanism is absent.

Additional features and advantages of these and other embodiments will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments of the present disclosure, and are intended to provide an overview or framework for understanding the nature and character of the embodiments as claimed. The accompanying drawings are included to provide a further understanding of these and other embodiments, and are incorporated into and constitute a part of this specification. The drawings illustrate various embodiments of these and other embodiments, and together with the description serve to explain the principles and operations thereof.

### BRIEF DESCRIPTION OF THE DRAWINGS

FIG. 1 is a schematic view of an apparatus for producing a glass article including a forming device in accordance with aspects of the disclosure;

FIG. 2 is a cross-sectional enlarged perspective view of the forming device of FIG. 1;

FIG. 3 is a cross-sectional view of a glass ribbon between two walls of a glass forming apparatus according embodiments disclosed herein;

FIG. 4 is a schematic representation of operation of a cooling and heating mechanism according to embodiments disclosed herein;

FIG. 5 is a cross-sectional view of a glass ribbon between two walls of a glass forming apparatus according embodiments disclosed herein;

FIG. 6 is a schematic representation of operation of a cooling and heating mechanism according to embodiments disclosed herein;

FIG. 7 is a cross-sectional view of a glass ribbon between two walls of a glass forming apparatus according embodiments disclosed herein;

FIG. 8 is a schematic representation of operation of a cooling and heating mechanism according to embodiments disclosed herein;

FIG. 9 is a cross-sectional view of a glass ribbon between two walls of a glass forming apparatus according embodiments disclosed herein; and

FIG. 10 is a schematic representation of operation of a cooling and heating mechanism according to embodiments disclosed herein.

### DETAILED DESCRIPTION

Reference will now be made to embodiments of the present disclosure, examples of which are illustrated in the accompanying drawings. Whenever possible, the same reference numerals will be used throughout the drawings to refer to the same or like parts.

As used herein, the term “in at least one wall of the apparatus” refers to an area that at least partially encloses an area of a glass manufacturing apparatus where the glass is cooled from at least temperatures including and below the glass working point to temperatures including and below the glass strain point and includes elements and materials in or on the wall, whether integral to the wall or attached to or within the wall, including one or more baffles.

As used herein, the term “cooling mechanism that enhances radiation heat transfer” refers to a mechanism that provides increased radiation heat transfer from the glass ribbon to a wall of the apparatus relative to a condition where such cooling mechanism is absent.

As used herein, the term “heating mechanism that affects radiation heat transfer” refers to a mechanism that provides decreased radiation heat transfer from the glass ribbon to a wall of the apparatus relative to a condition where such heating mechanism is absent. Notably, the heating mechanism that affects radiation heat transfer may include heating elements that are at a higher, lower, or approximately equal temperature than the temperature of the portion of the glass ribbon that is in closest proximity to the heating elements.

As used herein, the term “working point” refers to the temperature in degrees Celsius at which the viscosity of the glass is 10⁴ poise.

As used herein, the term “softening point” refers to the temperature in degrees Celsius at which the viscosity of the glass is 10^{7.6} poise.

As used herein, the term “annealing point” refers to the temperature in degrees Celsius at which the viscosity of the glass is 10¹³ poise.

As used herein, the term “strain point” refers to the temperature in degrees Celsius at which the viscosity of the glass is 10^{14.5} poise.

Embodiments disclosed herein can enable improved cooling of glass, such as glass sheets, at increasingly high glass flow rates and reduced thicknesses, for example, at glass temperatures between 200° C. and the working point of the glass, which can broadly be defined as a temperature range that encompasses the settling zone of the glass or the temperature range in which various properties are imputed into the glass depending on, for example, the composition and cooling rate of the glass at a given temperature. Such temperature range can also include a temperature range between the softening point and the strain point of the glass, including temperature ranges between the softening point and annealing point of the glass and between the annealing point and the strain point of the glass.

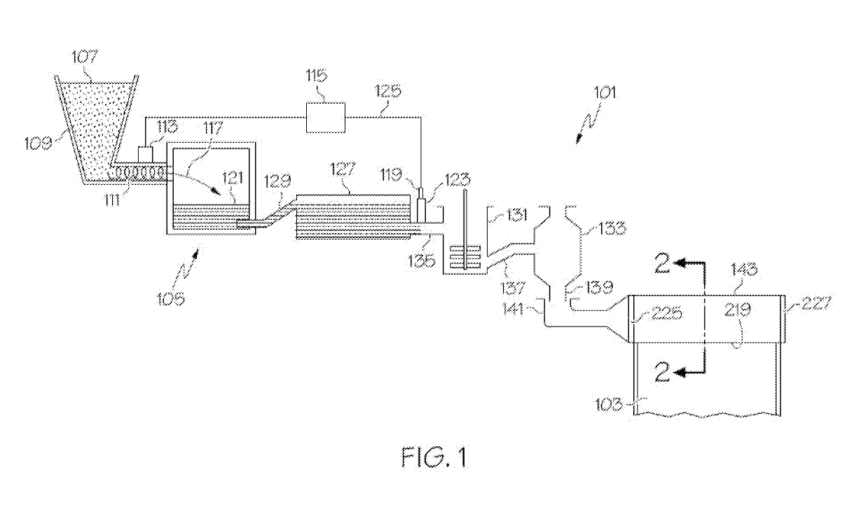

FIG. 1 illustrates an exemplary schematic view of a glass forming apparatus 101 for fusion drawing a glass ribbon 103 for subsequent processing into glass sheets. The illustrated glass forming apparatus comprises a fusion draw apparatus although other fusion forming apparatus may be provided in further examples. The glass forming apparatus 101 can include a melting vessel (or melting furnace) 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by an arrow 117. A glass level probe 119 can be used to measure a glass melt (or molten glass) 121 level within a standpipe 123 and communicate the measured information to the controller 115 by way of a communication line 125.

The glass forming apparatus 101 can also include a fining vessel 127, such as a fining tube, located downstream from the melting vessel 105 and fluidly coupled to the melting vessel 105 by way of a first connecting tube 129. A mixing vessel 131, such as a stir chamber, can also be located downstream from the fining vessel 127 and a delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver glass melt 121 from the delivery vessel 133 to an inlet 141 of a forming device 143. As shown, the melting vessel 105, fining vessel 127, mixing vessel 131, delivery vessel 133, and forming device 143 are examples of glass melt stations that may be located in series along the glass forming apparatus 101.

The melting vessel 105 is typically made from a refractory material, such as refractory (e.g. ceramic) brick. The glass forming apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide. The platinum-containing components can include one or more of the first connecting tube 129, the fining vessel 127 (e.g., finer tube), the second connecting tube 135, the standpipe 123, the mixing vessel 131 (e.g., a stir chamber), the third connecting tube 137, the delivery vessel 133 (e.g., a bowl), the downcomer 139 and the inlet 141. The forming device 143 is made from a ceramic material, such as the refractory, and is designed to form the glass ribbon 103.

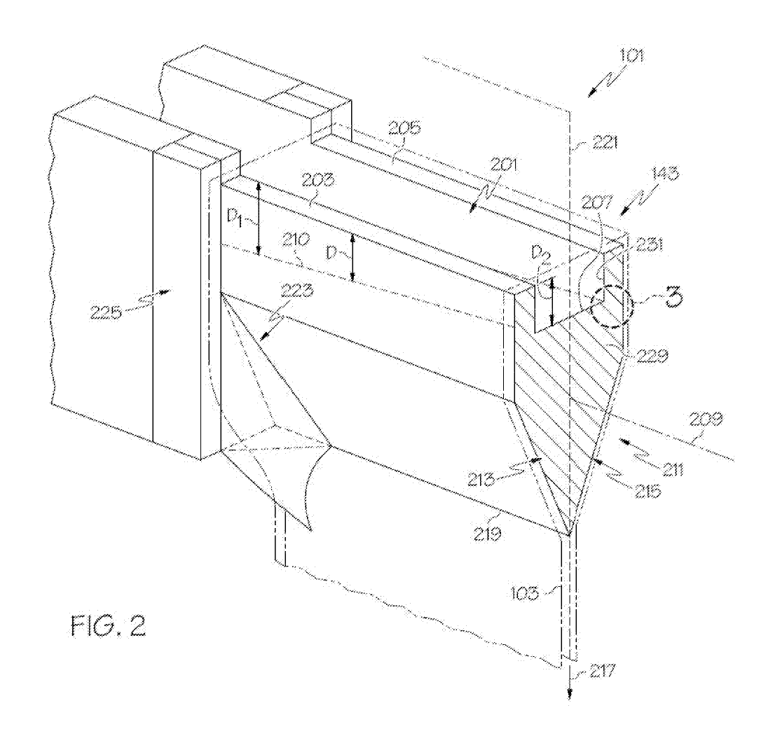

FIG. 2 is a cross-sectional perspective view of the glass forming apparatus 101 along line 2-2 of FIG. 1. As shown, the forming device 143 can include a trough 201 at least partially defined by a pair of weirs comprising a first weir 203 and a second weir 205 defining opposite sides of the trough 201. As further shown, the trough may also be at least partially defined by a bottom wall 207. As shown, the inner surfaces of the weirs 203, 205 and the bottom wall 207 define a substantially U shape that may be provided with round corners. In further examples, the U shape may have surfaces substantially 90° relative to one another. In still further examples, the trough may have a bottom surface defined by an intersection of the inner surfaces of the weirs 203, 205. For example, the trough may have a V-shaped profile. Although not shown, the trough can include further configurations in additional examples.

As shown, the trough 201 can have a depth “D” between a top of the weir and a lower portion of the trough 201 that varies along an axis 209 although the depth may be substantially the same along the axis 209. Varying the depth “D” of the trough 201 may facilitate consistency in glass ribbon thickness across the width of the glass ribbon 103. In just one example, as shown in FIG. 2, the depth “D₁” near the inlet of the forming device 143 can be greater than the depth “D₂” of the trough 201 at a location downstream from the inlet of the trough 201. As demonstrated by the dashed line 210, the bottom wall 207 may extend at an acute angle relative to the axis 209 to provide a substantially continuous reduction in depth along a length of the forming device 143 from the inlet end to the opposite end.

The forming device 143 further includes a forming wedge 211 comprising a pair of downwardly inclined forming surface portions 213, 215 extending between opposed ends of the forming wedge 211. The pair of downwardly inclined forming surface portions 213, 215 converge along a downstream direction 217 to form a root 219. A draw plane 221 extends through the root 219 wherein the glass ribbon 103 may be drawn in the downstream direction 217 along the draw plane 221. As shown, the draw plane 221 can bisect the root 219 although the draw plane 221 may extend at other orientations with respect to the root 219.

The forming device 143 may optionally be provided with one or more edge directors 223 intersecting with at least one of the pair of downwardly inclined forming surface portions 213, 215. In further examples, the one or more edge directors can intersect with both downwardly inclined forming surface portions 213, 215. In further examples, an edge director can be positioned at each of the opposed ends of the forming wedge 211 wherein an edge of the glass ribbon 103 is formed by molten glass flowing off the edge director. For instance, as shown in FIG. 2, the edge director 223 can be positioned at a first opposed end 225 and a second identical edge director (not shown in FIG. 2) can be positioned at a second opposed end (see 227 in FIG. 1). Each edge director 223 can be configured to intersect with both of the downwardly inclined forming surface portions 213, 215. Each edge director 223 can be substantially identical to one another although the edge directors may have different characteristics in further examples. Various forming wedge and edge director configurations may be used in accordance with aspects of the present disclosure. For example, aspects of the present disclosure may be used with forming wedges and edge director configurations disclosed in U.S. Pat. No. 3,451,798, U.S. Pat. No. 3,537,834, U.S. Pat. No. 7,409,839 and/or U.S. Provisional Pat. Application No. 61/155,669, filed Feb. 26, 2009 that are each herein incorporated by reference in its entirety.

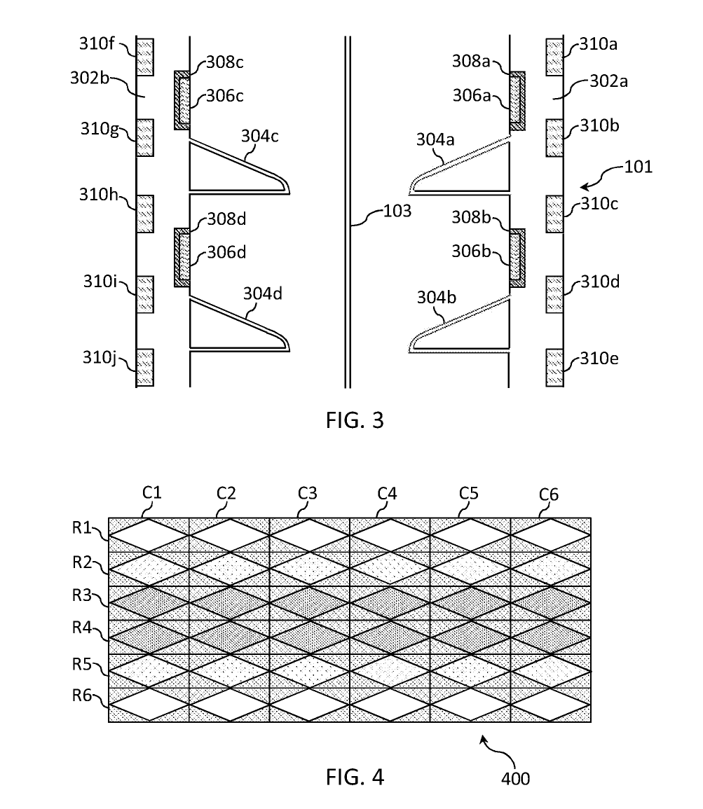

FIG. 3 is a cross-sectional view of a glass ribbon 103 between first wall 302a and second wall 302b of a glass forming apparatus 101. Each of walls 302a and 302b may, for example, comprise a steel frame. The interior portion of first wall 302a comprises a plurality of baffles, shown in FIGS. 3 as 304a and 304b. The interior portion of second wall 302b also comprises a plurality of baffles, shown in FIGS. 3 and 304c and 304d. Baffles may comprise the same or different material than the material that comprises the bulk of the walls. While FIG. 3 shows two baffles in each of first and second walls 302a, 302b, it is to be understood that embodiments disclosed herein are not so limited and may comprise any number of baffles, such as at least one baffle, including from 1 to 1,000 baffles, and further including from 2 to 500 baffles and yet further including from 5 to 200 baffles in each wall of the apparatus.

Each of walls 302a and 302b includes a cooling mechanism that, as described in greater detail below, enhances radiation heat transfer between molten glass and the wall of the apparatus and is tunable in both the vertical and horizontal directions. Each of walls 302a and 302b also includes a heating mechanism that, as described in greater detail below, affects radiation heat transfer between molten glass and a wall of the apparatus, is tunable in both the vertical and horizontal directions, and is independently operable from the cooling mechanism.

Specifically, in the embodiment illustrated in FIG. 3, each of first wall 302a and second wall 302b includes a cooling mechanism that includes fluid flow in a conduit. In particular, first wall 302a includes a plurality of conduits, shown in FIGS. 3 as 310a, 310b, 310c, 310d, and 310e, wherein the conduits are housed within the interior of the wall. Similarly, second wall 302b includes a plurality of conduits, shown in FIGS. 3 as 310f, 310g, 310h, 310i, and 310j, wherein the conduits are housed within the interior of the wall. While FIG. 3 shows five conduits in each of first and second walls 302a, 302b, it is to be understood that embodiments disclosed herein are not so limited and may comprise any number of conduits, such as at least one conduit, including from 1 to 1,000 conduits, and further including from 2 to 500 conduits and yet further including from 5 to 200 conduits in each wall of the apparatus.

Fluid flowing through the conduits may, for example, be a gas, such as air, or a liquid. In certain exemplary embodiments the fluid is a liquid, and in a particular exemplary embodiment the fluid is water.

In exemplary embodiments the fluid flowing through the conduits has a temperature of less than 100° C., such as less than 90° C., and further such as less than 80° C., including from 20° C. to 100° C., and further including from 30° C. to 90° C., and yet further including from 40° C. to 80° C.

For example, in a preferred exemplary embodiment, the fluid is water at a temperature of less than 100° C., such as less than 90° C., and further such as less than 80° C.

Fluid flowing through the conduits may flow from one side of the apparatus to the other, such as from the side closest to the inlet side of the glass forming device to the side closest to the compression side of the glass flowing device or vice versa. Alternatively, fluid may flow from near the center of each wall toward the ends of each wall (i.e., in opposite directions from the center to the ends of the walls).

Each of the conduits may be individually controlled such that fluid flowing in different conduits is at similar or different temperatures and/or flow rates. For example, in some conduits, the temperature and/or flow rate of the fluid may be at the same or different temperatures than the temperature and/or flow rate of the fluid in other conduits. Moreover, the same or different fluids may flow through different conduits. For example, a gas, such as air, may flow through at least one conduit while, in at least one other conduit, a liquid, such as water, may flow.

Still further yet, each of the conduits may extend through only a portion of the length of each wall of the apparatus. For example, each wall of the apparatus may comprise an array of rows and columns of conduits extending in the X and Y directions along the wall. Each of the conduits in the array of conduits may be individually controlled such that fluid flowing in different conduits is at similar or different temperatures and/or flow rates. For example, in some conduits, the temperature and/or flow rate of the fluid may be at the same or different temperatures than the temperature and/or flow rate of the fluid in other conduits. Moreover, the same or different fluids may flow through different conduits. For example, a gas, such as air, may flow through some conduits while, in other conduits, a liquid, such as water, may flow. In this manner, the cooling mechanism may be tunable in both the vertical and horizontal directions.

Radiation heat transfer via the cooling mechanism can be further enhanced coating each of the interiors of walls 302a and 302b (i.e., the sides of the walls that are closest to glass ribbon 103) with a high emissivity coating, such as high emissivity ceramic coatings available from Cetek Ceramic Technologies. Such high emissivity coatings can be coated on the outer surfaces of baffles, shown in FIGS. 3 as 304a, 304b, 304c, and 304d.

Radiation heat transfer can also be enhanced by the inclusion of at least one cooling bayonet (not shown in FIG. 3), such as at least four cooling bayonets, in an upper region of the forming apparatus 101 below the forming wedge 211.

Radiation heat transfer can also be enhanced by the removal of insulation baskets (not shown in FIG. 3) that would otherwise be present above and/or below the baffles.

Additional heat transfer can be effected by increasing the amount of convective heat transfer within the apparatus, such as by creating at least a partial vacuum within the apparatus that thereby increases convective fluid flow, such as air flow, within the apparatus, such as between or within each of walls 302a and 302b, including fluid flow, such as air flow, within baffles 304a-d. Examples of embodiments of such enhanced convective heat transfer mechanisms are disclosed in U.S. application Ser. No. 61/829,566, the entire disclosure of which is incorporated herein by reference.

In the embodiment shown in FIG. 3, each of walls 302a and 302b includes a heating mechanism. Specifically, first wall 302a includes a plurality of heating elements, shown in FIG. 3 as 306a and 306b. Second wall 302b also includes a plurality of heating elements, shown in FIGS. 3 as 306c and 306d. Each of heating elements 306a-d are located on the interior surface of walls 302a, 302b, that is the side of the walls that is closest to glass ribbon 103. While FIG. 3 shows two heating elements in each of first and second walls 302a, 302b, it is to be understood that embodiments disclosed herein are not so limited and may comprise any number of heating elements, such as at least one heating element, including from 1 to 2,000 heating elements, and further including from 2 to 1,000 heating elements and yet further including from 5 to 500 heating elements in each wall of the apparatus.

While FIG. 3 shows heating elements 306a-d on interior surfaces of the walls closest to the glass ribbon 103, it is to be understood that embodiments disclosed herein include those in which heating elements are housed within the interiors of the walls. For example, in certain exemplary embodiments, some heating elements may be arranged on the interior surface of each wall (as shown, for example, in FIG. 3) while other heating elements are housed within the interior of each wall.

Heating elements, in certain exemplary embodiments may be electrical resistive heating elements. For example, in certain embodiments, the heating elements may comprise electrically resistive heating elements available from Kanthal. In certain embodiments, the heating elements may comprise at least one material selected from the group consisting of molybdenum disilicide (MoSi₂) and alloys of iron, chromium, and aluminum (FeCrAl). Temperatures of electrical heating elements, when in operation, may, for example, range from 1,200° C. to 1,900° C., such as from 1,300° C. to 1,800° C., and further such as from 1,400° C. to 1,700° C.

Each of the heating elements may be individually controlled. For example, each of the heating elements may be controlled such that the temperature or percent power saturation of some heating elements may be the same or different than the temperature of percent power saturation of other heating elements.

Still further yet, each of the heating elements may extend through only a portion of the length of each wall of the apparatus. For example, each wall of the apparatus may comprise an array of rows and columns of heating elements extending in the X and Y directions along the wall. Each of the heating elements in the array of heating elements may be individually controlled. For example, the temperature or percent power saturation may be the same or different in some heating elements than the temperature or percent power saturation in other heating elements. In this manner, the heating mechanism may be tunable in both the vertical and horizontal directions. In this manner, the heating mechanism may also be independently operable from the cooling mechanism.

Radiation heat transfer via the heating mechanism can be further affected by positioning sufficient thermal insulation between the heating elements and the bulk of the walls of the apparatus. As shown in FIG. 3, thermal insulation 308a is positioned between heating element 306a first wall 302a, thermal insulation 308b is positioned between heating element 306b and first wall 302a, thermal insulation 308c is positioned between heating element 306c and second wall 302b, and thermal insulation 308d is positioned between heating element 306d and second wall 302b.

While not limited to any particular material, thermal insulation, in certain exemplary embodiments, has a thermal conductivity of less than 5.0 W/mK, such as less than 2.5 W/mK, and further such as less than 1.0 W/mK, and still further such as less than 0.5 W/mK, and still yet further such as less than 0.25 W/mK at 600° C., such as from 0.1 to 5.0 W/mK, including from 0.1 to 2.0 W/mK, and further including from 0.1 to 1.0 W/mK, and still further including from 0.1 to 0.5 W/mK, and still yet further including from 0.1 to 0.25 W/mK at 600° C. Exemplary materials for thermal insulation include those comprising Fiberfrax® alumino silicate fibers from Unifrax.

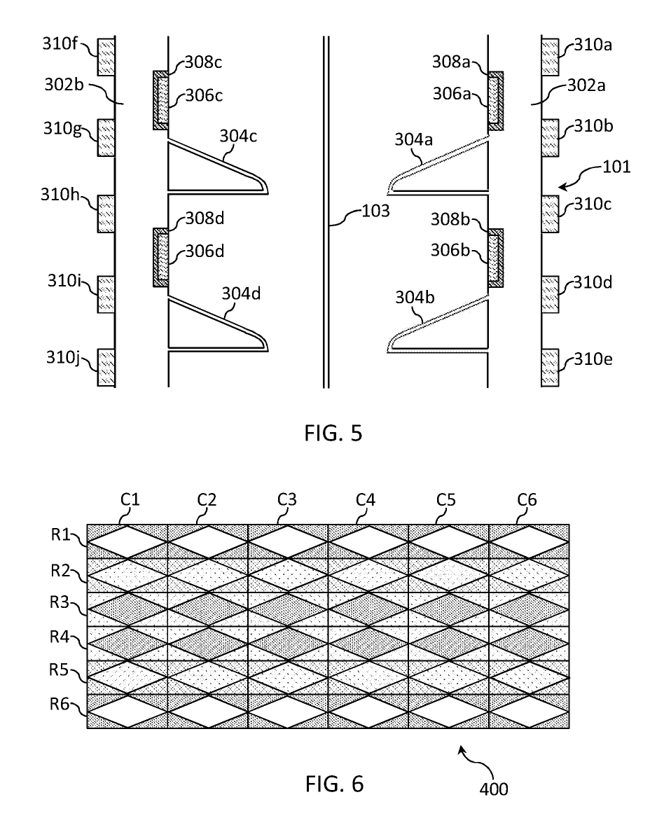

FIG. 5 is a cross-sectional view of a glass ribbon 103 between first wall 302a and second wall 302b of a glass forming apparatus 101 that is similar to the embodiment illustrated in FIG. 3, except conduits 310a-j are positioned on the outer surfaces of first and second walls 302a and 302b.

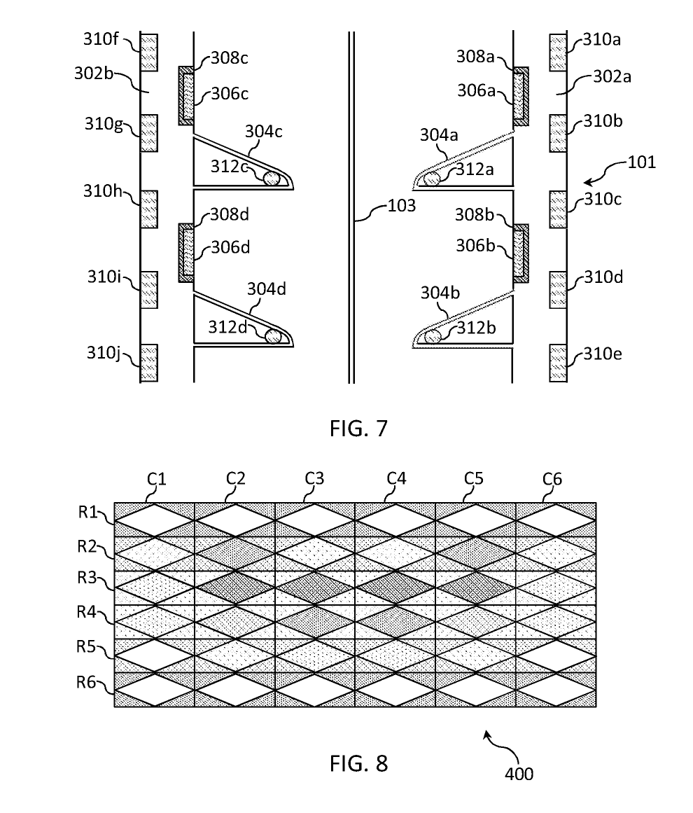

FIG. 7 is a cross-sectional view of a glass ribbon 103 between first wall 302a and second wall 302b of a glass forming apparatus 101 that is similar to the embodiment illustrated in FIG. 3, except baffles 304a-d, each include fluid flow conduits 312a-d, wherein conduit 312a corresponds to baffle 304a, conduit 312b corresponds to baffle 304b, conduit 312c corresponds to baffle 304c, and conduit 312d corresponds to baffle 304d. In the embodiment illustrated in FIG. 7, conduits are positioned near the portion of the baffle that is closest to the glass ribbon 103, however, it is to be understood that embodiments disclosed herein include those in which conduits are positioned in other areas of the baffles, as well as embodiments where the conduits have geometries that contact larger surface areas of the baffles, as well as embodiments where there are two or more conduits within the same baffle.

Fluid flowing through the baffle conduits may, for example, be a gas, such as air, or a liquid. In certain exemplary embodiments the fluid is a liquid, and in a particular exemplary embodiment the fluid is water.

In exemplary embodiments the fluid flowing through the baffle conduits has a temperature of less than 100° C., such as less than 90° C., and further such as less than 80° C., including from 20° C. to 100° C., and further including from 30° C. to 90° C., and yet further including from 40° C. to 80° C.

For example, in a preferred exemplary embodiment, the fluid is water at a temperature of less than 100° C., such as less than 90° C., and further such as less than 80° C.

When the baffle conduits extend from one side of the wall to the other, fluid may flow from near the center of each wall toward the ends of each wall (i.e., in opposite directions from the center to the ends of the walls).

Each of the baffle conduits may be individually controlled such that fluid flowing in different baffle conduits is at similar or different temperatures and/or flow rates. For example, in some baffle conduits, the temperature and/or flow rate of the fluid may be at the same or different temperatures than the temperature and/or flow rate of the fluid in other baffle conduits. Moreover, the same or different fluids may flow through different baffle conduits. For example, a gas, such as air, may flow through at least one baffle conduit while, in at least one other baffle conduit, a liquid, such as water, may flow.

Still further yet, each of the baffle conduits may extend through only a portion of the length of each wall of the apparatus. For example, each wall of the apparatus may comprise an array of rows and columns of baffle conduits extending in the X and Y directions along the wall. Each of the baffle conduits in the array of conduits may be individually controlled such that fluid flowing in different baffle conduits is at similar or different temperatures and/or flow rates. For example, in some baffle conduits, the temperature and/or flow rate of the fluid may be at the same or different temperatures than the temperature and/or flow rate of the fluid in other baffle conduits. Moreover, the same or different fluids may flow through different baffle conduits. For example, a gas, such as air, may flow through some baffle conduits while, in other conduits, a liquid, such as water, may flow. In this manner, the cooling mechanism may be further tunable in both the vertical and horizontal directions.

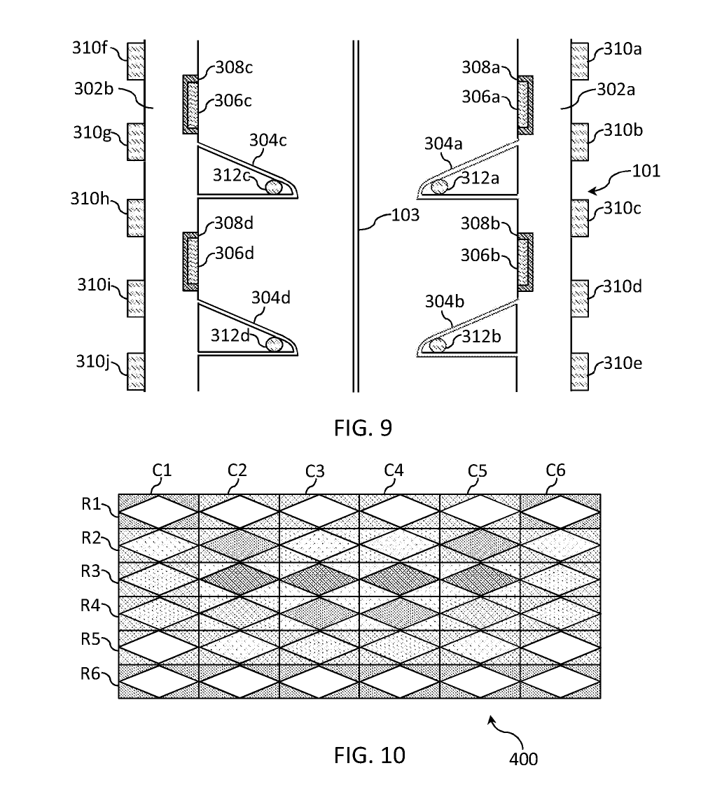

FIG. 9 is a cross-sectional view of a glass ribbon 103 between first wall 302a and second wall 302b of a glass forming apparatus 101 that is similar to the embodiment illustrated in FIG. 7, except conduits 310a-j are positioned on the outer surfaces of first and second walls 302a and 302b.

Accordingly, embodiments disclosed herein include those in which the cooling mechanism comprises at least two cooling mechanism components, namely a first cooling mechanism component and a second cooling mechanism component, wherein the first cooling mechanism component includes fluid flow in a conduit that is at a relatively farther distance from the glass ribbon than the second cooling mechanism component, such as within the interior of a wall of the apparatus as shown, for example, in FIG. 7, or on an outer surface of a wall of the apparatus as shown, for example, in FIG. 9. The second cooling mechanism component includes fluid flow in a conduit that is closer to the glass ribbon than the first cooling mechanism component, such as within a baffle conduit as shown, for example, in FIGS. 7 and 9. Fluid flowing through the conduits of the first and second components of the cooling mechanism may, for example, be the same or different and may be a gas or a liquid. In certain exemplary embodiments, the fluid flowing through conduits of both the first and second components of the cooling mechanism is a liquid, and in a particular exemplary embodiment the fluid is water.

When acting in concert, the first and second components of the cooling mechanism may involve fluid flows at the same or different flow rates and temperatures. For example, each wall of the apparatus may comprise an array of rows and columns of conduits of each of the first and second components of the cooling mechanism, the conduits extending in the X and Y directions along the wall. Each of the conduits of either component of the cooling mechanism may be individually controlled such that fluid flowing in different conduits is at similar or different temperatures and/or flow rates.

Embodiments disclosed herein, including those described above, can enable production of glass at increasingly high flow rates and reduced thickness, which production follows, as closely as possible, a predetermined cooling curve that enables the production of glass sheets with superior properties such as density, compaction, Young's Modulus, Specific Modulus, coefficient of thermal expansion, Poisson's Ratio, as well as low stress and warp. For example, embodiments disclosed herein can enable production of glass at increasingly high flow rates having a thickness of less than 0.5 millimeters, a density of less than 2.6 g/cm³, a Young's Modulus of at least 65 GPa, and warp of less than 100 microns.

For example, as the glass flow rate is increased, the cooling mechanism can be adjusted or tuned in at least one of the vertical and horizontal directions to extract more heat from the apparatus to compensate for the increased energy imputed into the apparatus as a result of the higher flow rate. At the same time, the heating mechanism can be adjusted or tuned in at least one of the vertical and horizontal directions to modify heat transfer between heating elements and the glass so as to enable the cooling of the glass at the increased flow rate to follow the predetermined cooling curve as closely as possible and adjust for any process drift. The cooling and heating mechanisms can also be adjusted to account not only for differing glass flow rates but also for different glass thicknesses as well as different glass compositions having different predetermined cooling curves.

In embodiments disclosed herein, a tuning algorithm can be employed, such as a process control algorithm, that, for example, accounts for the thermal response of different glass compositions at different flow rates in an apparatus and then adjusts each of the cooling and heating mechanisms in real time to enable the cooling of the glass to, as closely as possible, follow a predetermined cooling curve. In certain embodiments, the tuning algorithm would employ a computer processor. In certain embodiments, the tuning algorithm can take into account the cooling of the glass in not only down draw direction but also across the draw, thereby enabling real time controlled cooling of the glass in both the vertical and horizontal directions.

The tunability of the cooling and heating mechanisms in both the vertical and horizontal directions can be further enhanced by incorporating at least one multiphase cooling and inductive heating element into any vertical or horizontal area of the device. Such elements can be operable to heat or cool the same area of a device depending on whether the multiphase cooling system is in operation or the inductive heating system is in operation. Exemplary multiphase cooling and inductive heating systems are disclosed in U.S. application Ser. No. 14/460,447, the entire disclosure of which is incorporated herein by reference.

FIG. 4 is a schematic representation of operation of a cooling and heating mechanism 400 according to embodiments disclosed herein. In the embodiment illustrated in FIG. 4, columns, C1-C6, are representative of areas across the draw (with C3 and C4 representing areas corresponding to the middle of the glass sheet and C1 and C6 representing areas corresponding to edges of the glass sheet). In contrast, rows, R1-R6, are representative of areas down the draw (with R1 being at a relatively higher point on the draw where glass is at a relatively higher temperature and R6 being at a relatively lower point on the draw where glass is at a relatively lower temperature). Within each of the cells, (C1-R1, etc.), the rectangular background areas are representative of the cooling mechanism and the diamond-shaped foreground areas are representative of the heating mechanism. Specifically, the greater the degree of shading within a cell, the greater the amount (or higher percentage relative to saturation) the respective cooling or heating of the cooling or heating mechanism in that region of the apparatus. For example, a rectangular background cell with a greater degree of shading indicates a greater amount of cooling from the cooling mechanism relative to a rectangular background cell with a lesser degree of shading. Similarly, a diamond-shaped area with a greater degree of shading indicates a greater amount of heating from the heating mechanism relative to a diamond-shaped area with a lesser degree of shading. No shading in a rectangular background cell or diamond-shaped area indicates that the respective cooling or heating mechanism is effectively turned off in that region of the apparatus. While the embodiment of FIG. 4 shows a 6×6 array of cells and columns it is to be understood that embodiments disclosed herein are not so limited and may include any number of rows and columns and may also include differing number of cells within different rows or columns.

In the embodiment of FIG. 4, the cooling mechanism is operated such that it is approximately constant across and down the apparatus. In contrast, the heating mechanism is operated such that it is approximately constant across the apparatus (at a given vertical point) but varies as a function of vertical height, with a greater amount of heating in the mid-height areas and a lesser amount of heating in higher and lower height areas. As can be seen in FIG. 4, embodiments disclosed herein encompass those in which both heating and cooling mechanisms are operating in the same area of the device.

FIG. 6 is another schematic representation of operation of a cooling and heating mechanism 400 according to embodiments disclosed herein. In the embodiment of FIG. 6, both the cooling and heating mechanisms are operated such that they are approximately constant across the apparatus (at a given vertical point) but vary as a function of vertical height, with a greater amount of heating in mid-height areas and a greater amount of cooling in higher and lower height areas.

FIG. 8 is another schematic representation of operation of a cooling and heating mechanism 400 according to embodiments disclosed herein. In the embodiment of FIG. 8, the cooling mechanism is operated such that it is approximately constant across the apparatus (at a given vertical point) but varies as a function of vertical height, with a greater amount of cooling in higher and lower height areas and a lesser amount of cooling in mid-height areas. In contrast, the heating mechanism varies in both the horizontal and vertical directions.

FIG. 10 is another schematic representation of operation of a cooling and heating mechanism 400 according to embodiments disclosed herein. In the embodiment of FIG. 10, both the cooling and heating mechanisms vary in both the horizontal and vertical directions.

As noted above, embodiments disclosed herein can enable production of glass at increasingly high flow rates, which production follows, as closely as possible, a predetermined cooling curve. For example, embodiments disclosed herein can include those in which, at varying glass flow rates, the cooling mechanism and heating mechanism are configured such that the glass is cooled at a faster average cooling rate when the glass is at temperatures between the strain point of the glass and 200° C. than when the glass is at temperatures between the softening point of the glass and the strain point of the glass. Such embodiments can also include those in which, at varying glass flow rates, the cooling mechanism and heating mechanism are configured such that the glass is cooled at a faster average cooling rate when the glass is at temperatures between the working point of the glass and the softening point of the glass than when the glass is at temperatures between the softening point of the glass and the strain point of the glass. Such embodiments can additionally include those in which, at varying glass flow rates, the cooling mechanism and heating mechanism are configured such that the glass is cooled at a faster average cooling rate when the glass is at temperatures between the annealing point of the glass and the strain point of the glass than when the glass is at temperatures between the softening point of the glass and the annealing point of the glass. Such embodiments can enable the production of thin glass sheets at relatively high molten glass flow rates, such as glass sheets having a thickness of less than 0.5 millimeters, while at the same time, following a predetermined cooling curve, wherein the environment surrounding the molten glass ribbon is minimally disruptive (which is particularly important for thin glass) and, therefore, amenable to stable production of high quality product with minimal process upset.

Exemplary glass working points, while not limited, include those from 1,100° C. to 1,500° C. Exemplary glass softening points, while not limited, include those from 800° C. to 1,200° C. Exemplary glass annealing points, while not limited, include those from 550° C. to 950° C. Exemplary glass strain points, while not limited, include those from 500° C. to 900° C.

While specific embodiments disclosed herein have been described with respect to an overflow downdraw process, it is to be understood that the principle of operation of such embodiments may also be applied to other glass forming processes such as flow processes and slot draw processes.

It will be apparent to those skilled in the art that various modifications and variations can be made to the embodiments of the present disclosure without departing from the spirit and scope of the disclosure. Thus, it is intended that the present disclosure cover the modifications and variations of these and other embodiments provided they come within the scope of the appended claims and their equivalents.

What is claimed is:

1. An apparatus for producing a glass article comprising:
a cooling mechanism in at least one wall of the apparatus that enhances radiation heat transfer between molten glass and the wall of the apparatus and is tunable in both the vertical and horizontal directions, wherein the cooling mechanism provides increased radiation heat transfer from the glass ribbon to a wall of the apparatus relative to a condition where the cooling mechanism is absent; and
a heating mechanism that affects radiation heat transfer between molten glass and the wall of the apparatus, is tunable in both the vertical and horizontal directions, and is independently operable from the cooling mechanism, wherein the heating mechanism provides decreased radiation heat transfer from the glass ribbon to a wall of the apparatus relative to a condition where the heating mechanism is absent.

2. The apparatus of claim 1, wherein the cooling mechanism comprises fluid flow in a conduit in the wall of the apparatus.

3. The apparatus of claim 2, wherein the fluid is a liquid.

4. The apparatus of claim 3, wherein the liquid is water.

5. The apparatus of claim 2, wherein the temperature of the fluid is less than 100° C.

6. The apparatus of claim 1, wherein the heating mechanism comprises at least one electrical resistive heating element.

7. The apparatus of claim 1, comprising an overflow downdraw forming device.

8. The apparatus of claim 2, wherein at least one fluid flow conduit in the wall of the apparatus is located in a baffle region.

9. The apparatus of claim 1, wherein the cooling mechanism and heating mechanism are configured such that the glass is cooled at a faster average cooling rate when the glass is at temperatures between the strain point of the glass and 200° C. than when the glass is at temperatures between the softening point of the glass and the strain point of the glass.

10. The apparatus of claim 9, wherein the cooling mechanism and heating mechanism are configured such that the glass is cooled at a faster average cooling rate when the glass is at temperatures between the working point of the glass and the softening point of the glass than when the glass is at temperatures between the softening point of the glass and the strain point of the glass.

11. The apparatus of claim 1, wherein the glass article is a glass sheet having a thickness of less than 0.5 millimeters.

12. A method of producing a glass article comprising forming the glass article in an apparatus comprising:
a cooling mechanism in at least one wall of the apparatus that enhances radiation heat transfer between molten glass and the wall of the apparatus and is tunable in both the vertical and horizontal directions, wherein the cooling mechanism provides increased radiation heat transfer from the glass ribbon to a wall of the apparatus relative to a condition where the cooling mechanism is absent; and
a heating mechanism that affects radiation heat transfer between molten glass and the wall of the apparatus, is tunable in both the vertical and horizontal directions, and is independently operable from the cooling mechanism, wherein the heating mechanism provides decreased radiation heat transfer from the glass ribbon to a wall of the apparatus relative to a condition where the heating mechanism is absent.

13. The method of claim 12, wherein the cooling mechanism comprises fluid flow in a conduit in the wall of the apparatus.

14. The method of claim 13, wherein the fluid is a liquid.

15. The method of claim 14, wherein the liquid is water.

16. The method of claim 13, wherein the temperature of the fluid is less than 100° C.

17. The method of claim 12, wherein the heating mechanism comprises at least one electrical resistive heating element.

18. The method of claim 12, wherein the apparatus comprises an overflow downdraw forming device.

19. The method of claim 13, wherein at least one fluid flow conduit in the wall of the apparatus is located in a baffle region.

20. The method of claim 12, wherein the cooling mechanism and heating mechanism are operated such that the glass is cooled at a faster average cooling rate when the glass is at temperatures between the strain point of the glass and 200° C. than when the glass is at temperatures between the softening point of the glass and the strain point of the glass.

21. The method of claim 20, wherein the cooling mechanism and heating mechanism are operated such that the glass is cooled at a faster average cooling rate when the glass is at temperatures between the working point of the glass and the softening point of the glass than when the glass is at temperatures between the softening point of the glass and the strain point of the glass.

22. The method of claim 12, wherein the glass article is a glass sheet having a thickness of less than 0.5 millimeters.
